(19) United States
(12) Patent Application Publication
(10) Pub. No.: US 2004/0233124 A1
(43) Pub. Date: Nov. 25, 2004

(54) Process for depicting various image data on a vehicle display

(76) Inventors: Helmuth Eggers, Ulm (DE); Gerhard Kurz, Wendlingen (DE); Juergen Seekircher, Ostfildern (DE); Thomas Wohlgemuth, Aichtal (DE)

Correspondence Address: PENDORF & CUTLIFF, 5111 Memorial Highway, Tampa, FL, 33634-7356, US

(21) Appl. No.: 10/807,721

(22) Filed: Mar. 24, 2004

(30) Foreign Application Priority Data
Mar. 24, 2003 (DE) 103 13 001.2

(51) Int. Cl. G09G 5/00

(52) U.S. Cl. 345/1.1

(57) ABSTRACT

Modern vehicles are equipped with image providing assist systems. Each of these systems conventionally includes a dedicated display for the depiction of system information. A process for imaging system information on a single vehicle display is provided herein, wherein in particular image data of various systems can be depicted. The image data associated with the system information are herein first subjected to prioritization on the basis of operating parameters and, depending upon the result of this prioritization, are subsequently depicted upon the vehicle display. As a result of prioritization the image parameters of the image data, and in particular the size, position and shape, are varied. Thereby it becomes possible that multiple image data associated with the prioritized system information can be simultaneously depicted or displayed.

### BACKGROUND OF THE INVENTION

1. Field of Invention

The invention concerns a process for depicting or displaying various image data or video data on a vehicle display.

Modern vehicles are equipped with various operator assist systems, which are designed to support the vehicle operator. Included with increasing frequency among these are image-providing environment surveillance systems. In the field of automobiles there are, for example, night vision systems wherein the vehicle environment ahead of the vehicle is detected using an infrared sensor. The detected environmental data is processed into an image using a data processing unit and depicted upon a display, whereupon it can be accessed by the vehicle operator as needed. A further example of an operator assist system is a navigation system, wherein the image of a road map is frequently presented on a display for the vehicle operator. In addition to these image producing systems, vehicles frequently use additional systems and devices which include a display and therewith provide information regarding the operating condition of the vehicle. The control of such displays usually occurs automatically via a control unit. As a result, the vehicle operator can concentrate primarily upon the road traffic, and meanwhile however continuously has available as needed information adapted to the actual situation as presented on the display of the assist system.

2. Related Art of the Invention

Japanese Patent applications with the publication numbers JP 2002048565 and JP 2002002425 describe a control unit for a display in a vehicle. The control unit includes a control means, via which a 3D-map can be represented on a display for navigation purposes. The 3D-map can, in a superimposing mode, additionally have superimposed an infrared image acquired with an infrared camera, which shows obstacles ahead of the vehicle. The control unit manages the positioning of the infrared image on the display in a superimposition or overlay mode. The arrangement on the display occurs, for example, in the case that the partial image area or screen area which includes the infrared image encompasses 50% or more of the total surface of the 3D-map. In the case that extremely poor visibility conditions exist, and no direct visual verification can be carried out by the vehicle operator, then only the 3D-map as well as route or direction symbols for the trip route are depicted.

The Japanese patent application with the publication number JP 2001071790 describes a display for a motor vehicle. The display can selectively be operated in an automatic mode or manually. In the automatic mode, in the case of simultaneous activated zoom functionality, an enlarged image segment or screen segment of an obstacle, which is in the environment of the vehicle, is depicted upon the display. Therein the complete full scene image can be represented in miniature within the enlarged image segment which shows the obstacle. The image segment which includes the obstacle is presented enlarged particularly in the case that the distance between the own vehicle and a detected obstacle is greater than a corresponding preset threshold value. The threshold value of the described distance criteria serves herein for prioritizing the system information, wherein herein the threshold value is adapted to the speed of the motor vehicle. Therewith a display is prepared for the vehicle, which makes it possible to recognize a distant obstacle ahead of the vehicle and to display this. In the video display, that obstacle in particular is depicted which is closest to the own vehicle and with which at the same time satisfies the threshold condition, that is, which exhibits the highest priority. The disadvantage herein with the prioritization with respect to the image data to be displayed is that only the system information provided by the camera system is taken into consideration.

### SUMMARY OF THE INVENTION

The present invention is thus concerned with the task of providing a process which, during prioritization with regard to image data to be displayed, takes into consideration information from various systems and makes possible a suitable display of prioritized image data.

This task is solved in accordance with the invention by the process with the characteristics of Patent claim 1. Advantageous embodiments and further developments are set forth in the dependent claims.

According to the invention a process is provided for display of various image data on a vehicle display. Therein system information is subjected to prioritization on the basis of operating parameters. The representation of the image data to be depicted upon the vehicle display is influenced as a result of this prioritizing. In an inventive manner system information from multiple systems are prioritized and multiple image data associated with the prioritized system information are simultaneously depicted. On the basis of the prioritizing the display parameters are changed in size and/or position and/or shape. With the invention it becomes possible to display image data from multiple systems simultaneously on a single display, wherein the type and manner of the representation of the image data automatically occurs on the basis of prioritizing of the system information. In particular, the prioritizing of the system information is herein undertaken on the basis of operating parameters and/or prior inputs by the vehicle operator.

In particularly preferred manner, the representation of various image data on the vehicle display occurs in the manner of a status display. For this, the vehicle display is subdivided in the manner that various screen segments result. One segment is associated with one status display. This status display is selectively or, depending upon the number of image data to be represented, further subdivided into partial image areas. In the partial image areas of the status display, image data of one system or various systems can be represented. This system information may have the same or may have different priorities. The status display is herein preferably presented in an edge area of the vehicle display, for example, at the upper or lower edge in the form of a status line. It is of course also conceivable that the image data is displayed in vertical arranged partial screen areas in the manner of a status column or in any other conceivable orientation.

With regard to at least one system information, the size of the described display parameter of the associated image data corresponds to the size of a full image. The size of a full image corresponds substantially with the usable size of the display. Preferably herein the image data associated with the highest priority have a display or representation parameter describing the size of a full image. Therewith the highest priority image data nearly completely fills the vehicle display, in comparison to which the image data of other systems take up a comparatively small surface area of the vehicle display, for example, those within a status display. It is however conceivable that the image data encompassing a full image requires the total surface area of the vehicle display, and the status displays then overlay the depiction of the full image or are suppressed. Since at least one representation parameter of the system information associated image data have the size of a partial image, it becomes possible that image data of multiple systems are simultaneously presentable also outside a status display, simultaneously in different screen segments. For example, in this manner image data associated with two different system informations having the same priority can be displayed at the same time, wherein the two screen segments containing the image data respectively require one half of the surface of the vehicle display. Of course, here also a subdivision into further partial screens is conceivable, each of which partial screens could each have the same size or have different sizes. The number and size of the partial displays is herein principally undertaken on the basis of the prioritization of the system information. However, the operator and/or additional control signals can establish a basically fixed predetermined upper limit for the maximal displayable number of image data, so that the driver is not flooded with information.

For the automated display of image data of multiple systems on one vehicle display, a display parameter is provided which defines the position of the image data on the vehicle display. In advantageous manner, at least one image parameter of the system information associated image data assigns a position within a partial screen. Therewith the respective image data can automatically be assigned to a position within a partial screen on the vehicle display, as determined by their priority. Further, it has been found advantageous when at least one display parameter of the image data associated with the system information exhibits a position within a status display. In accordance therewith, image data can automatically be assigned to a status display in a screen segment within a position determined by their priority. Therein it is also conceivable that system information for a particular system is associated with a fixed position on the display.

Since image data of different systems are displayed or depicted in accordance with the process, it is particularly advantageous when at least one display or image parameter of the image data associated with the system information exhibits a symbolic form. For example, navigation system information allows itself to be depicted particularly well in the form of navigation symbols as image information. Therewith also symbols of vehicle internal systems, which are already employed with conventional displays in motor vehicles, can be displayed or imaged without problem with the inventive process. At the same time it is advantageous when at least one image parameter of the image data associated with the system information exhibits a text form. This text form could be numbers as well as letters. For example, numbers are preferably employed for displaying distance, time or speed values. In contrast, letters can be employed for example for displaying service information. Here it is also conceivable to assign to each system a distinctive identification code, wherein this identification code can be depicted in the status display, for example, in order therewith to indicate whether a system is currently active or inactive.

It is also conceivable that all of the various pieces of image information are simultaneously displayed. For this the position, size as well as shape of descriptive image parameters of the image are automatically adapted on the basis of the prioritization of the system information. For example, the various image data are either displayed as full or partial screen images or displayed within a status display. An image segment to be displayed is automatically adapted to the remaining available display segments or surface area. The display surfaces still available can be called up for example via a CAN-bus of the vehicle. It is however also conceivable that the driver has direct input on the prioritization and/or image parameter. Beyond this, there is the possibility that the image data are not adapted to the still remaining display surface, but rather, image data are overlayed over each other. Therein for example only the position of the image information is automatically adapted.

### BRIEF DESCRIPTION OF THE DRAWINGS

Further characteristics and advantageous embodiments can be seen from the following description of illustrative embodiments on the basis of the figures in the field of motor vehicles. There is shown:

FIG. 1 motor vehicle display with full-screen video image display and status display,

FIG. 2 motor vehicle display with partial-screen image display and status display, and

FIG. 3 motor vehicle display with partial-screen display and adapted status display.

### DETAILED DESCRIPTION OF THE INVENTION

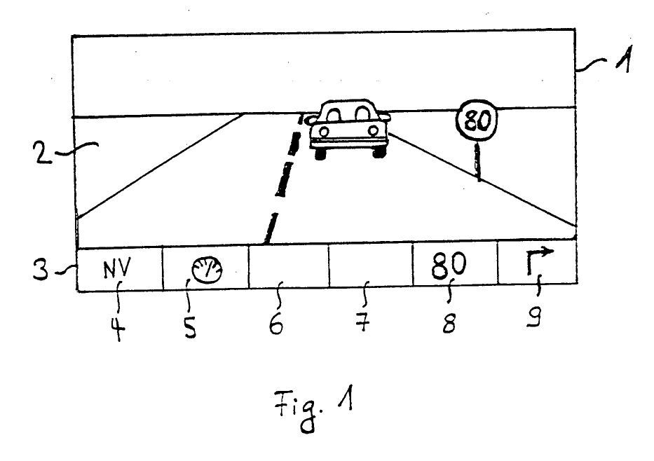

FIG. 1 shows a motor vehicle display (1), which is subdivided into a full image display (2) and a status display (3). Within the full image display (2) a video scene is depicted, which shows the environment ahead of the motor vehicle. Here it is in particular an environment under surveillance with a night vision system “NV”. The status display (3) is in the form of a status line at the lower edge of the motor vehicle display (1) and includes herein the partial screen areas (4) through (9). These partial screen areas include image data of multiple systems. The image in text form with the sign “NV” in the screen image area (4) of the status display (3) indicatess for example the activated condition of the night vision system. In the partial image area (5) a control readout is depicted in symbol form, which indicates the operating temperature of the motor vehicle. In the partial image areas (6) and (7), these are part screen areas for additional systems, which at this time are inactive. Part screen area (8) provides the maximal permissible speed in numbers as detected in the framework of a traffic sign recognition system. The symbol in part screen area (9) shows the driver the anticipated change in direction of travel as determined by a navigation system. The image data depicted within status display (3) is herein arranged in the manner that priority increases in sequence from right to left. It would alternatively also be conceivable, that the partial screen areas (6) and (7) are positioned at the location of the partial screen areas (8) and (9), or the reverse. Thereby no open areas would result in the depiction of the image data. System information which is subsequently to be displayed can then be automatically inserted in the form of image data at the respective position in accordance with their priority.

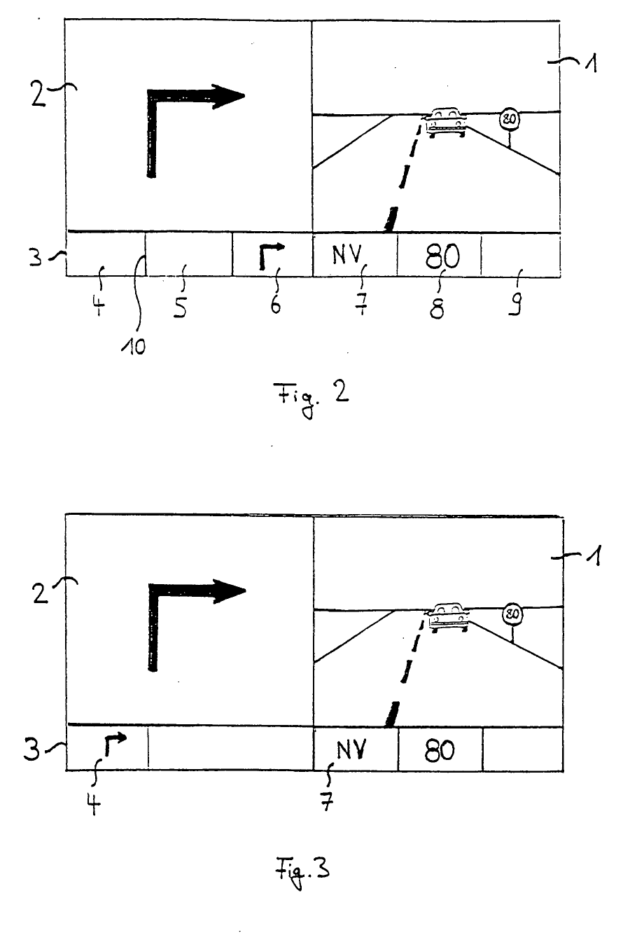

In FIG. 2 the two partial screen areas (1) and (2), as well as the status display (3) are displayed on the motor vehicle display. The two partial screen areas (1) and (2) have, on the basis of operating parameters, herein perhaps differing priorities, but are however nevertheless imaged with the same size. The positions of the image information in the part screen areas (4) through (9) are changed within the status display (3) in comparison to FIG. 1. Therein the partial screen areas (4) through (9) are associated in the horizontal direction with the respective partial screen areas (1) or (2) of a system. Therein the image information with highest priority can be associated with the right edge of a partial screen, as this is shown in the example of a partial screen (2) and the navigation symbol in screen part (6). At the same time it is conceivable that the highest priority image information is assigned to the left edge of a part screen, as this is shown in the example of the part screen (1) and the text “NV” in partial screen area (7). It would also be conceivable that the highest priority screen part (6) or as the case may be (7) occurs in horizontal direction directly in the center below the associated partial screen (1) or as the case may be (2). The same applies with respect to the vertical direction, in case the status display (3) is oriented vertically in the form of a status column. Since the positions of the part screen areas (4) and (5) within the status display (3) have no image information currently depicted, it would also be conceivable that the subdividing by the separating line (10) is not displayed.

FIG. 3 shows the same part image areas (1) and (2) on the motor vehicle display as in FIG. 2. In contrast to the FIG. 2, the part screen areas in the status display (3) are however adapted. In particular the navigation symbol (4) is imaged at the left edge of the vehicle display. Therewith the highest priority part screen areas (4) and (7) are positioned at the left edge of the status display (3) relative to the associated part screens (1) and (2). Of course there is the possibility that the vehicle operator personalizes the presets for the size, position and shape of image areas to be displayed.

1-8. (Cancelled)

9. A process for displaying a variety of image data on a vehicle display, comprising:
prioritizing system information from multiple systems on the basis of operating parameters,
modifying a display of the image data to be depicted on the vehicle display on the basis of the result of the prioritization,
wherein multiple image data associated with the prioritized system information is displayed simultaneously, and
wherein the display parameters of the image data are varied in size and/or position and/or shape on the basis of their prioritization.

10. A process according to claim 9, wherein the depiction of different image data on the vehicle display occurs in the form of a status display.

11. A process according to claim 9, wherein with regard to at least one system information the size-describing image parameter of the associated image data corresponds to the size of the full image, and wherein the size of a full image corresponds to the greater part of the usable size of the display.

12. A process according to claim 9, wherein at least one image or display parameter of the image data associated with the system information describes a position within a partial screen.

13. A process according to claim 9, wherein at least one image or display parameter of the image data associated with the system information describes a position within a status line.

14. A process according to claim 9, wherein image data associated with the system information is in the form of a symbol.

15. A process according to claim 9, wherein image data associated with the system information is in text form.

16. A process according to claim 9, wherein all the various image data are simultaneously depicted.
